(19) United States
(12) Patent Application Publication
(10) Pub. No.: US 2007/0102918 A1
(43) Pub. Date: May 10, 2007

(54) Waterproof or water-compatible book with storage for manipulatives

(75) Inventor: Shari Kaufman, Westport, CT (US)

Correspondence Address: HEDMAN & COSTIGAN P.C., 1185 AVENUE OF THE AMERICAS, NEW YORK, NY, 10036, US

(73) Assignee: Innovative USA, Inc.

(21) Appl. No.: 11/268,044

(22) Filed: Nov. 7, 2005

(51) Int. Cl. B42D 1/00

(52) U.S. Cl. 281/15.1

(57) ABSTRACT

The present invention provides a book with a storage compartment that is useful in the bathtub or other water environments and wherein the storage compartment stores manipulatives for use with the book and/or decorative objects and/or liquids.

### FIELD OF THE INVENTION

The present invention is in the field of books combined with entertainment or educational manipulative pieces and more particularly relates to a waterproof or water-compatible book that may float and that is provided with a storage container for storing or displaying one or more waterproof or water compatible manipulative pieces, or toys. More particularly, the present invention provides for ease of storage of manipulatives or objects, prevents loss of manipulatives or toys and, where container is made partially or completely of porous material, provides for ease of drying of manipulatives or toys. The container also may be used to display decorative objects or liquids or any combination thereof.

### BACKGROUND OF THE INVENTION

It is a goal of all parents and society as a whole to encourage children to learn to read. Children's books of all shapes and sizes are common in the marketplace. One way to encourage children to learn to read is to combine reading with the child's ordinary activities of life, such as eating, bathing, swimming, going to sleep and playing games. This can be accomplished by simply reading to the child during these activities. A more active child-centered approach is to combine books with manipulative pieces or game pieces for use with the book, especially where the book is related to these ordinary activities so that the child can become actively engaged in the process, thereby facilitating his or her learning process.

A variety of books currently on the market have manipulative pieces or game pieces for use with the book. These types of books especially have a high degree of educational and/or entertainment value for children.

The general concept of attaching associated manipulatives to the books or other printed matter, such as magazines and albums, is well known. One method is to attach the manipulatives to the cover of the book with a pressure sensitive adhesive whereby the consumer can peel off the manipulative from the book. In U.S. Pat. Nos. 5,301,803 and 5,303,825, both Hansen et al., cassettes are attached to printed sheets.

In Grant, U.S. Pat. No. 5,584,387, there is disclosed a combination book and package case assembly wherein the package case for containing the manipulatives is attached to a spiral binding by means of a hinge strip onto which the package case may be attached. However, this type of embodiment is severely limited to manipulatives which are relatively flat.

Special mention is made of Kaufman, U.S. Pat. No. 6,079,748, which disclosed a useful combination book and storage container, wherein the storage container contains manipulatives for use with the book.

However, none of these embodiments is suited to combining reading with the child's recurrent activity of bathing. Normal books are destroyed by water. If placed in contact with water, the paper pages and cardboard or cloth covers of books soften and become misshapen. Inks printed on paper, cardboard and cloth can run, smear and become illegible and impossible to read. Also, normal books, when placed in water, naturally sink, making them impossible to read. Special mention also is made of Kaufman, U.S. Pat. No. 6,070,909, which discloses a book made entirely of foam and has utility in the bath. See also, U.S. Pat. No. 4,280,241. Normal manipulatives combined with normal books likewise can be damaged or destroyed by contact with water and/or sink to the bottom of the bathing tub or body of water. Also, prior art books having manipulatives for use in or around the water suffer from marketing problems, such as but not limited to, having insufficiently thick spines for shelving and capturing the eye of prospective purchasers; loss of manipulatives; and an inability to allow the manipulatives to dry during storage.

Accordingly, it would represent an advancement in the art of books and attaching manipulatives to books if a book were designed so that it would overcome the above-noted drawbacks in the prior art.

### SUMMARY OF THE INVENTION

It is an object of the present invention to provide a waterproof or water-compatible book that can be enjoyed while bathing or swimming. It is another object of the present invention to provide a book that floats, thereby facilitating its use while bathing or swimming. It is another object of the present invention to provide a book that can be employed with one or more waterproof or water-compatible manipulative pieces while bathing or swimming. It is a further object of the present invention to provide a book with a storage or display means for decorative objects or liquids and/or waterproof or water-compatible manipulatives. It is another object of the invention to provide for ease of storage and prevention of loss of the manipulatives as well as to provide for ease of drying of the manipulatives while they are in storage. It is a still further object to provide a storage compartment that serves both to provide a place for storing the manipulatives and that provides a spine that will prominently display the book while on the shelf of a store or library.

To achieve the foregoing objects, there is disclosed a floatable book, comprising a waterproof or water-compatible front cover, a waterproof or water-compatible back cover, at least one waterproof or water-compatible page between the front and back covers, and a storage container made of waterproof or water-compatible material, and a waterproof or water-compatible means for attaching the storage container to said front or back cover, or both front and back covers, wherein one or more waterproof or water-compatible manipulatives, that may be floatable, may be stored in the container. The container may also be permanently closed and used to display decorative objects or liquids or any combination thereof.

In the preferred embodiments, the manipulatives are suitable for use with or related to the theme of the book. It is also contemplated herein that the container may be of a cylindrical construction and that at least a portion of the container is relatively transparent and/or porous. The partial or complete transparency and/or porosity of the container has many purposes. In the case of a container that is at least partially transparent these purposes may include, but are not limited to, allowing the manipulative or manipulatives to be seen through the container, allowing water to enter at least a portion of the container so that the waterproof or water-compatible manipulative(s) can be seen moving about in the water within the container, and allowing decorative objects and/or liquids to be permanently stored in the container, yet able to be viewed from outside. In the case of a porous or netted container, another purpose of the container may be to allow manipulatives that have been immersed in water when the book was in use, to dry, i.e., when the book is removed from water and the manipulatives are stored in the container, air passing through the netting or pores allows the manipulatives to dry.

### BRIEF DESCRIPTION OF THE DRAWINGS

FIG. 1 depicts a side view of an embodiment of the present invention wherein the book is in a closed position.

FIG. 2 depicts a top view of an embodiment of the present invention wherein the book is in an open position.

FIG. 3 depicts a front view of an embodiment of the present invention wherein the book is in a closed position and the cap for the container for storing manipulatives is in an open position.

### DETAILED DESCRIPTION OF THE PRESENT INVENTION AND DESCRIPTION OF THE PREFERRED EMBODIMENTS

The following detailed description of preferred embodiments is for illustrative purposes only and should not be construed to limit the scope of the appended claims in any manner whatsoever.

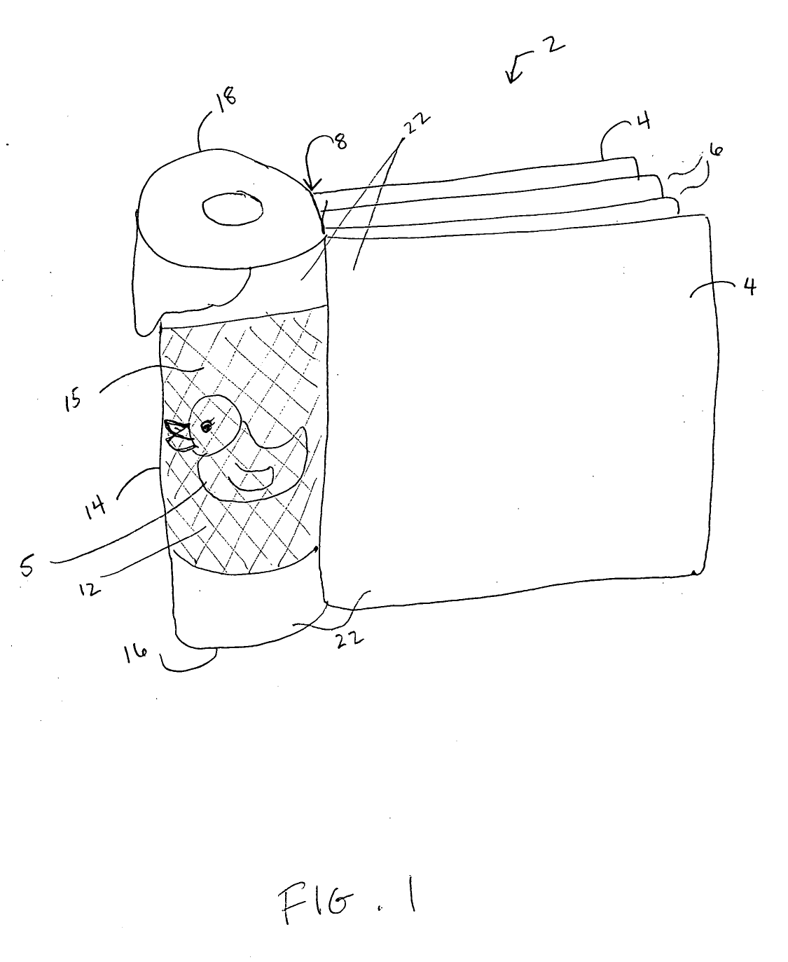

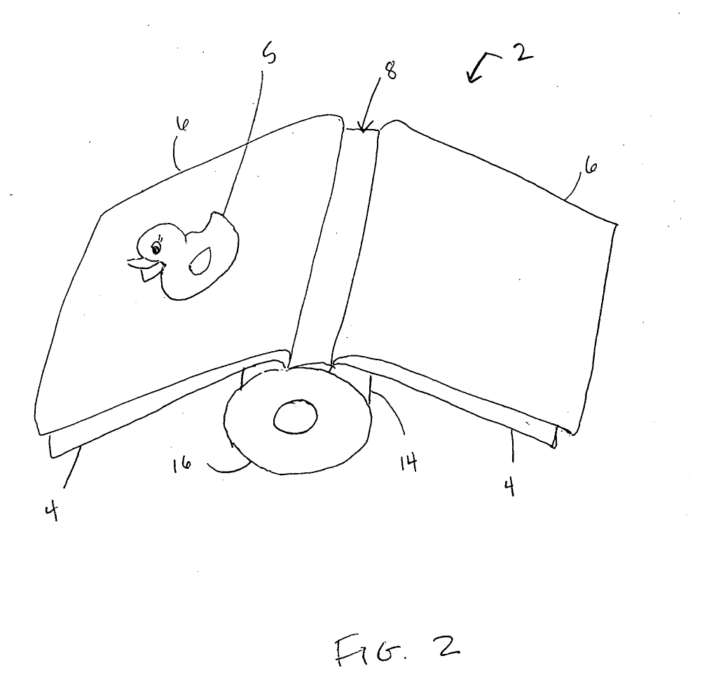

FIG. 1 depicts a front view and FIG. 2 depicts a top view of a book of the present invention. The book 2 has a front cover 4 and a plurality of pages 6 which are bound together with a waterproof or water-compatible binding 8. The front and back covers 4 may be constructed of any material known to those skilled in the art that provides sufficient printability. This material may be waterproof or water-compatible itself or may be covered with a waterproof or water-compatible material. The material may be floatable itself or may be constructed in such a way to incorporate air pockets or plastic foam or other floatable materials. Preferably, the material is washable. These materials may include, but are not limited to, waterproof or water-compatible coated paper, cardboard and/or textiles and plastics. Especially preferred is a plastic material comprised of polyvinyl chloride or ethyl vinyl acetate sheeting.

The binding 8 of the book may be affected by any of the well-known conventional waterproof or water-compatible means, i.e., by binding, such as by ultrasonically welding, stitching, with a plastic saddle wire or with a plastic spiral wire or other material wound through a multitude of holes punched through the pages. The binding 8 of compatible pages and covers also may be affected by sealing them together with a process using heat which fuses the pages and covers together at the spine of the book. These and other types of bindings are well known to those of ordinary skill in the art. The embodiment of FIG. 1 shows the use of a book with plastic or plastic covered pages 6 and covers bound together 8 by a heat or ultrasonic welding sealing process.

Also attached to the binding 8 is a storage container 14. The waterproof or water-compatible container 14 may take any of a variety of convenient shapes suitable for containing the waterproof or water-compatible manipulatives 5. For example, the container may be cylindrical, polyhedronic, such as having a triangular cross section, or any other shape, for example, having a fish-shaped cross section. The container 14 may be transparent, colored or non-transparent as desired. In order to provide a better viewing of the manipulatives 5, at least a partially transparent clear or transparent colored container is typically employed. The container also may be constructed partially or completely of netting 12 (or other porous material) so that, not only can the manipulatives 5 be viewed inside the container, but water can enter the container, so the waterproof or water-compatible manipulatives 5 may be seen floating and/or moving about within the container. Where the container 14 is partially or completely of netting 12, such an embodiment of the invention facilitates the drying of the manipulatives 5 when the manipulatives are stored in the container 14 after having been used in the water. The ends of the container are fitted with a sealing means such as plugs or caps 16 and 18, which may be openable and closable. Of course other types of sealing means may be employed which provide ingress into and egress out of the container for the manipulatives 5, such as a hinged door type cap with a Velcro closure. The caps 16 and 18 serve to contain the manipulatives 5 within the container 14 to provide for ease of storage and to prevent loss of the manipulatives. The caps 16 and/or 18 may be provided with means to assist in their opening and closing, such as a handle. One of the caps 16 or 18 may be sealed so as not to open to provide a more secure containment of the manipulatives and/or a floating device where desired. The container may also be permanently sealed in order to display decorative objects and/or liquids.

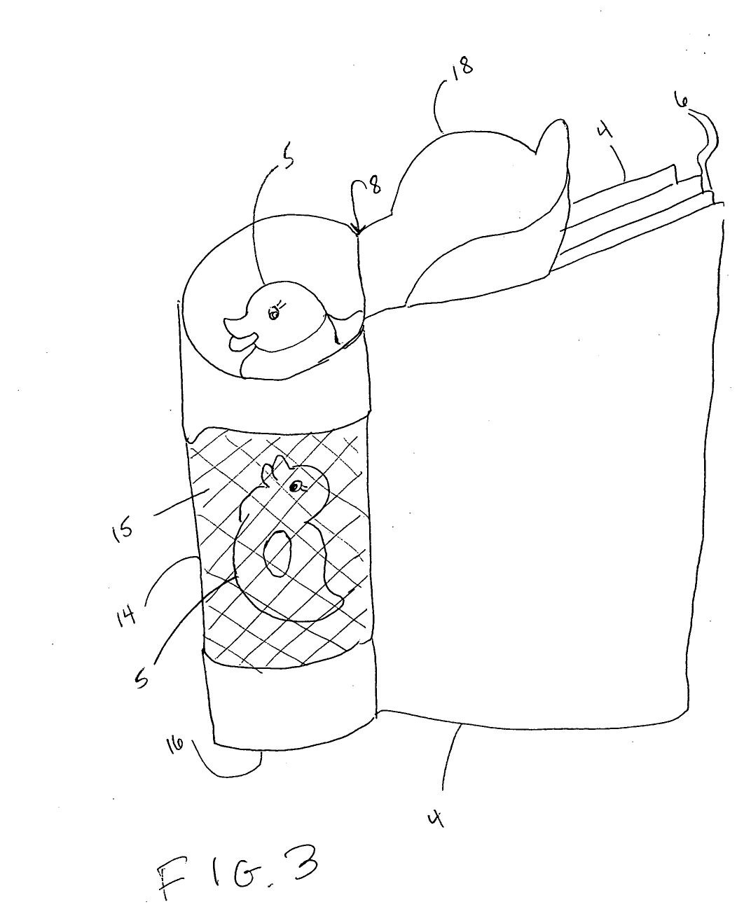

The container 14 may be constructed of any waterproof or water-compatible material known to those skilled in the art that provides sufficient printability and washability. This material may be waterproof or water-compatible itself or may be coated with a waterproof or water-compatible material. The material may be floatable itself or may be constructed in such a way to incorporate air pockets or plastic foams or other floatable materials. These materials may include but are not limited to waterproof coated paper, cardboard and/or textiles and plastics. Especially preferred is a plastic comprised of polyvinyl chloride (PVC) or ethyl vinyl acetate (EVA) sheeting. The container 14 may be attached to the book in a variety of ways. In a preferred embodiment, as shown in FIGS. 1 and 2, the container is attached to the back cover 12 with a sheet of plastic 22 having one end which is adhered to the back cover 4. The sheet 22 then wraps around the container 14 and the other end is adhered to the side of the front cover 4. In another preferred embodiment, where a transparent or partially transparent container 14 is employed, the sheet 22 may have a transparent plastic window therein and or a window of netting 15 therein. Text and/or designs may be printed on the sheet to further enhance the marketability of the book. FIG. 3 shows the cap for the container 14 for holding manipulatives 5 in an open position for removal of the manipulatives 5.

It is noted that the manner of adhering the container to the book is not critical to the present invention and any means of adhering may be employed without departing from the spirit of the claimed invention. FIGS. 1, 2 and 3 merely show one embodiment, and other adhering embodiments will be readily apparent to those of ordinary skill in the art.

Further, it is contemplated that the container 14 may function as part of the spine of the book. In such embodiment the container 14 would act as the spine of the book and provide space for printing and/or for a decorative design for merchandising purposes in the wholesale and retail market. This is an especially important feature in shelving and the marketability of a book.

As shown in FIG. 2, in an embodiment where the container is not porous, when the book is in the open position, the front and back covers 4, the container 14 and/or the pages 6 provide a platform that will float in water to further enhance the enjoyment of the book by the user. Moreover, when the container 16 floats supported in whole or in part by the floating covers 4 and pages 6, the pages 6 are on an incline, which forms a slide or ramp out of pages 6.

The manipulatives may be of any shape that is imaginable to the person designing the book and preferably relate to the subject matter of the book. For example, in the case of a bath book about ducks, the manipulatives may be plastic ducks. Moreover, if the book is a counting book about ducks, the number of duck manipulatives in the container may correspond to the number of ducks for counting in the books. Such embodiments will add to both the educational and entertainment value of the book. In preferred embodiments, the books of the present invention and the associated manipulatives will have water related themes water themes such as but not limited to, ducks and other waterfowl; fish, whales and other creatures that live in, feed in or travel through or on water; imaginary water creatures; swimmers, divers, surfers and other persons who play or work in, on or around water; imaginary people or creatures or machines that live, play or work in, on or around water; boats, rafts, barges, submarines, oil rigs, docks, light houses, bridges and other man- or machine-made or imaginary structures which are associated with use near, on or in water; islands, atolls, volcanoes, coastlines, bays, lakes and/or other natural land formations or imaginary land or space formations which may be associated with water.

In other embodiments, the manipulative(s) may interact with the book, such as having the book require placement of a manipulative on a book component. In this regard, the manipulative may be removably attachable to the book, such as by employment of magnets, string, Velcro, buttons, snaps, zippers and the like, such as are known to those skilled in the art.

Many variations of the present invention will suggest themselves to those skilled in the art in light of the above-detailed description. For example, the pages, covers and container of the book may be in any shape, such as a shape that corresponds to a theme of the book. For example, with regard to a book theme relating to water, the book could be star-shaped, fish-shaped, boat-shaped or the like. The container may be clear and may be constructed of a wide variety of materials, or the container may be transparent and colored, or the container may be porous with thematic shapes punched out of the material forming the container. The manipulatives for use with the present invention may comprise plastic figures, water-compatible mechanical figures and/or toys that can float on the water and the like. All such obvious modifications are within the full intended scope of the appended claims.

The above-mentioned patents hereby are incorporated by reference.

1. A waterproof or water-compatible, floatable book, said book comprising the following components:
a waterproof or water-compatible front cover;
a waterproof or water-compatible back cover;
optionally, at least one waterproof or water-compatible page between said front and back covers;
said front cover, back cover and any optional page or pages being attached along one side to form the spine of said book;
said book further comprising a waterproof or water-compatible storage container, said container being attached to the spine of said book;
and wherein said book floats in water.

2. A book as defined in claim 1, wherein said container has at least one end that may be opened and closed and wherein one or more waterproof or water-compatible manipulatives may be stored in said container.

3. A book as defined in claim 1, in which said container is sealed, allowing decorative objects and/or liquids to be permanently or semi-permanently stored in said container.

4. A book as defined in claim 1 wherein the storage container is at least partially transparent.

5. A book as defined in claim 2 wherein the storage container is at least partially made of a netting, webbing or material having perforations that allows water to enter the container during use of the book and allows air to enter the container when book is removed from water.

6. A book as defined in claim 2 wherein said manipulatives relate to a theme of the book.

7. A book as defined in claim 6 wherein said manipulatives are interactive with the book.

8. A book as defined in claim 7 wherein said manipulatives interact with the book by being removably attachable to a book component.

9. A book as defined in claim 8 wherein said manipulatives are removably attachable to a book component by magnet, string, two-piece connecting tape where one tape is equipped with hooks and the other tape is equipped with loops so that the tapes may be joined by pressure, snaps, buttons and combinations of any the foregoing.

10. A book as defined in claim 3 wherein said decorative objects and/or liquids relate to a theme of the book.

11. A book as defined in claim 6 wherein said theme of the book is a water-related theme.

12. A book as defined in claim 10 wherein said theme of the book is a water-related theme.

13. A book as defined in claim 1 wherein said book comprises from about 1 to about 10 pages.

14. A book as defined in claim 1 wherein the components of the book are comprised of a plastic material.

15. A book as defined in claim 14 wherein said plastic is polyvinyl chloride or ethyl vinyl acetate sheeting.

16. A book as defined in claim 1 wherein said book is washable.
